(19) United States
(12) Patent Application Publication
(10) Pub. No.: US 2023/0214693 A1
(43) Pub. Date: Jul. 6, 2023

(54) SEQUENCE PREDICTION EXPLANATION USING CAUSAL CHAIN EXTRACTION BASED ON NEURAL NETWORK ATTRIBUTIONS

(71) Applicant: BMC Software, Inc., Houston, TX (US)

(72) Inventors: Sai Eswar Garapati, Hyderabad (IN); Erhan Giral, Danville, CA (US)

(21) Appl. No.: 17/646,706

(22) Filed: Dec. 31, 2021

(51) Int. Cl. G06N 5/04; G06N 3/04

(52) U.S. Cl. CPC G06N 5/045; G06N 3/049

(57) ABSTRACT

Described systems and techniques perform causal chain extraction for an investigated event in a system, using a neural network trained to represent a temporalsequence of events within the system. Such neural networks, by themselves, may be successful in predicting or characterizing system events, without providing useful interpretations of causation between the system events. Described techniques use the representational nature of neural networks to perform intervention testing using the neural network, distinguish confounding events, and identify a probabilistic root cause of the investigated event.

### TECHNICAL FIELD

This description relates to explanation of sequence predictions of neural networks.

### BACKGROUND

Various artificial intelligence (AI) and machine learning (ML) techniques have been used to interpret, classify, and otherwise leverage large and/or complex sets of data. For example, such techniques have been used to classify objects in images, or to detect patterns in, e.g., financial data, information technology (IT) data, or weather data.

A neural network is a specific type of AI/ML technique(s) in which nodes are interconnected in a manner intended to correspond to neurons in the brain that are connected by synapses. A neural network typically has input neurons, hidden (computational) layer(s), and output neurons. As with many types of AI/ML techniques, neural networks may be trained using known or ground truth data, and then deployed to provide a trained, intended function, such as classification of current data and/or prediction of future data.

Some neural networks are used for sequence predictions for events that occur over time. For example, Recurrent Neural Networks (RNNs) refer to specific examples of neural networks that are used with sequential or chronological data. For example, RNNs may be used in scenarios in which first data is received at a first time, second data is received at a second time, third data is received at a third time, and so on. Once trained, RNNs may use such historical data to assist in predicting future data, e.g., to infer characteristics of fourth data at a fourth time based not just on the values of the first, second, and third data, but on the relationships therebetween, as well. For example, RNNs may be used in natural language processing (NLP), in which a next word in a sentence may be predicted based in part on a sequence of (and relationships between) earlier words in the sentence.

Although RNNs and other neural networks are extremely valuable for providing intended results, it is often difficult or impossible to interpret or explain the results. For example, in complex systems with many inputs and sequences of interactions, it is difficult or impossible to determine a manner and extent to which an input(s) had a causal effect on an output(s). In a particular example of large IT systems, it is difficult to determine specific, root causes of IT system events.

### SUMMARY

According to one general aspect, a computer program product is tangibly embodied on a non-transitory computer-readable storage medium. The computer program product comprises instructions that, when executed by at least one computing device, are configured to cause the at least one computing device to monitor a system using a neural network trained to represent a temporal sequence of events within the system, and store system state data determined by the neural network, for each of a plurality of timesteps corresponding to the temporal sequence of events including a first event, a second event, and a third event. First intervention testing may be performed using the neural network to identify the second event as having a first causal effect with respect to the third event, including substituting first intervention test data within the system state data for processing by the neural network to determine the first causal effect. Second intervention testing may be performed using the neural network to identify the first event as having a second causal effect with respect to the second event, including substituting second intervention test data within the system state data for processing by the neural network to determine the second causal effect. A causal chain of events that includes the first event, the second event, and the third event may be generated, based on the first intervention testing and the second intervention testing, and including the first causal effect and the second causal effect.

According to other general aspects, a computer-implemented method may perform the instructions of the computer program product. According to other general aspects, a system, such as a mainframe system or a distributed server system, may include at least one memory, including instructions, and at least one processor that is operably coupled to the at least one memory and that is arranged and configured to execute instructions that, when executed, cause the at least one processor to perform the instructions of the computer program product and/or the operations of the computer-implemented method.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for sequence prediction explanation using causal chain extraction based on neural network attributions.

FIG. 2 is a flowchart illustrating example operations of the system of FIG. 1.

FIG. 3 is a block diagram illustrating an example system in which the system of FIG. 1 may be used.

FIG. 4 is a diagram illustrating graph conversion of a neural network for intervention testing.

FIG. 5 is a diagram illustrating extraction of causal chain for the examples of FIGS. 1-4.

FIG. 6 is a graph illustrating a first example of a potential confounder variable.

FIG. 7 is a graph illustrating a second example of a potential confounder variable.

FIG. 8 is a graph illustrating an example node ranking for root cause analysis.

FIG. 9 is a flowchart illustrating more detailed examples of the flowchart of FIG. 2.

FIG. 10 is a flowchart illustrating more detailed examples of the intervention testing of FIG. 4.

FIG. 11 is a flowchart illustrating more detailed examples of the confounder filtering of FIGS. 6 and 7.

FIG. 12 is a flowchart illustrating more detailed example of the root cause analysis ranking of FIG. 8.

FIG. 13 is a block diagram of an example causal chain extracted using the techniques of FIGS. 1-11.

FIG. 14 is a block diagram illustrating an example of root cause analysis using the causal chain of FIG. 13.

### DETAILED DESCRIPTION

Described systems and techniques enable insights into causal associations, identification of root causes, and analyses of effects in complicated systems. Accordingly, with the described systems and techniques, decision-making may be improved across diverse areas such as, e.g., IT management, medical procedures, public infrastructure enhancements, or financial ventures.

Existing methods for causal discovery from data rely on statistical analyses of observational data. For example, existing methods may collect actual data from complex systems and then use various types of inference techniques to determine pairs of events in which a first event of a pair of events is determined to be a cause of a second event (effect) of the pair.

Some existing methods attempt to provide analysis or interpretation of predictions made by neural networks. For example, a trained neural network characterizing an IT environment that includes various routers, switches, servers, and other components may be used to identify or predict malfunctions (or potential malfunctions) within the IT environment. Then, input and output data of such a neural network may be analyzed to determine potential correlations between particular inputs and outputs.

All such existing techniques may be prone to miss or mischaracterize causal effects (e.g., may mischaracterize a correlation as being causative), or determine spurious correlations between events, or may fail to identify any specific cause. Moreover, such techniques rely on analysis of actual or observational data, and therefore may be limited in the types and amounts of data that may be available for use in analysis efforts.

For example, in an IT environment, system data may be tracked, and one or more neural networks may be used to provide alerts or predict future malfunctions. However, if the IT environment operates in a stable manner, there will be no (or few) malfunctions to analyze and learn from. Further, as IT environments are typically deployed for the use and convenience of many employees, customers, or other users, it is impractical and undesirable to deliberately intervene with functional systems to cause malfunctions in order to obtain test data for testing such malfunctions. For example, causing a malfunction of a router or server may disrupt service to many different customers.

In contrast, described techniques exploit a representational nature of neural networks to perform intervention testing on complex systems, such as IT environments. In other words, a neural network may be considered to be a representation or model of an underlying system. Described techniques provide a neural network (or representation thereof) with inputs, and obtain corresponding outputs, to provide baseline or control data. Then, individual inputs may be changed in a desired manner to determine causal effects of each such input on corresponding output(s).

Whereas existing techniques attempt to identify causal pairs within complex systems, described techniques identify causal chains of three or more events. Events (nodes) of such causal chains may be identified even when event pairs of the identified causal chains are separated in time by intervening events. For example, a first event at a first time may have a significant causal effect on a third event at a third time. Such a scenario may occur even when an intervening second event occurs at an intervening second time, which has little or no causal effect on the third event at the third time.

For example, described techniques may begin with an event (malfunction) of a system that is modeled by a neural network, such as a recurrent neural network (RNN). As referenced above, the RNN may be constructed to analyze system data at each of multiple sequential timesteps, using preceding timestep data to help interpret current timestep data. Therefore, beginning at the timestep of the event being analyzed, described techniques work backwards in time to preceding timesteps.

At each analyzed preceding timestep, intervention testing as referenced above may be used to evaluate (e.g., provide a score for) events at the preceding timestep(s) for a type or extent of causal effect on the timestep of the event being tested. For example, for an event (malfunction) being tested, a degree of causal effect of a preceding event at a preceding timestep may be scored against a causal threshold. If the causal threshold is met or exceeded, the scored event may be retained in the causal chain being constructed. Otherwise, if the causal threshold is not met, the scored event may not be included, and the process may continue to analyze an event at a next most recent preceding timestep.

As a RNN may have multiple inputs, there may be multiple paths to follow when analyzing preceding events. That is, for example, multiple preceding inputs and/or outputs being tested may occur at a single preceding timestep of the sequence of timesteps. However, described techniques may use a greedy search procedure to focus on following only those paths that are most likely to contribute to the event being investigated. Therefore, an exhaustive search is not required, and searching of multiple paths may proceed in parallel. Consequently, the techniques described herein may be repeated for each investigated path, and the resulting identified paths may be merged or combined to obtain a merged causal chain.

When identifying causal chains of events, described techniques also distinguish between causal events and confounding events. As described in detail, below, a confounding event generally refers to an event (e.g., variable) that commonly causes multiple events (variables), which may lead to confusion regarding causation between the multiple events. To give a simple example, smoking may cause bad breath and cancer, but bad breath does not cause cancer. Although such a simple example illustrates the point, existing systems are unable to consistently identify confounding events in more realistic, complicated examples.

Once a causal chain has been identified and confounding nodes have been removed, a root cause analysis may be performed to determine one or more root causes of the original event (e.g., malfunction) being investigated. For example, nodes of the causal chain may be evaluated based on, e.g., a number of connections (e.g., outgoing connections to subsequent nodes). Additionally, or alternatively, causal nodes of a causal chain may be evaluated based on a scaled strength or degree of causation determined from the interventional testing. The individual nodes of the causal chain may then be ranked from most to least likely to represent a root cause node.

Thus, described techniques exploit the representational power of deep learning using a framework that determines a causal chain between different input and output neurons by discovering causal relationships using interventional data. As described above, predictions of a Recurrent Neural Network model solving a sequence prediction problem may be interpreted as multiple causal chains involving various inputs and outputs that are causally related, in which inputs in one time step may be causally linked to inputs in a next or subsequent time step.

In example implementations, described in detail below, such dependencies may be inferred by representing the neural network architecture as structural causal models (SCMs). SCMs may be used to extract the causal effect between different inputs on corresponding outputs, using causal attributions that characterize an extent of corresponding causal effects. SCMs may further be implemented to use the extracted causal effects to generate a causal chain over inputs from different timesteps, including identifying confounders between different nodes to determine a relevant and accurate representation of the causal chains. Then, as also referenced above, probabilistic root causes may then be determined using various search and analysis techniques with respect to the determined causal chains, including, e.g., applied network centrality algorithms applied to extracted causal chains, as referenced above and described in more detail, below.

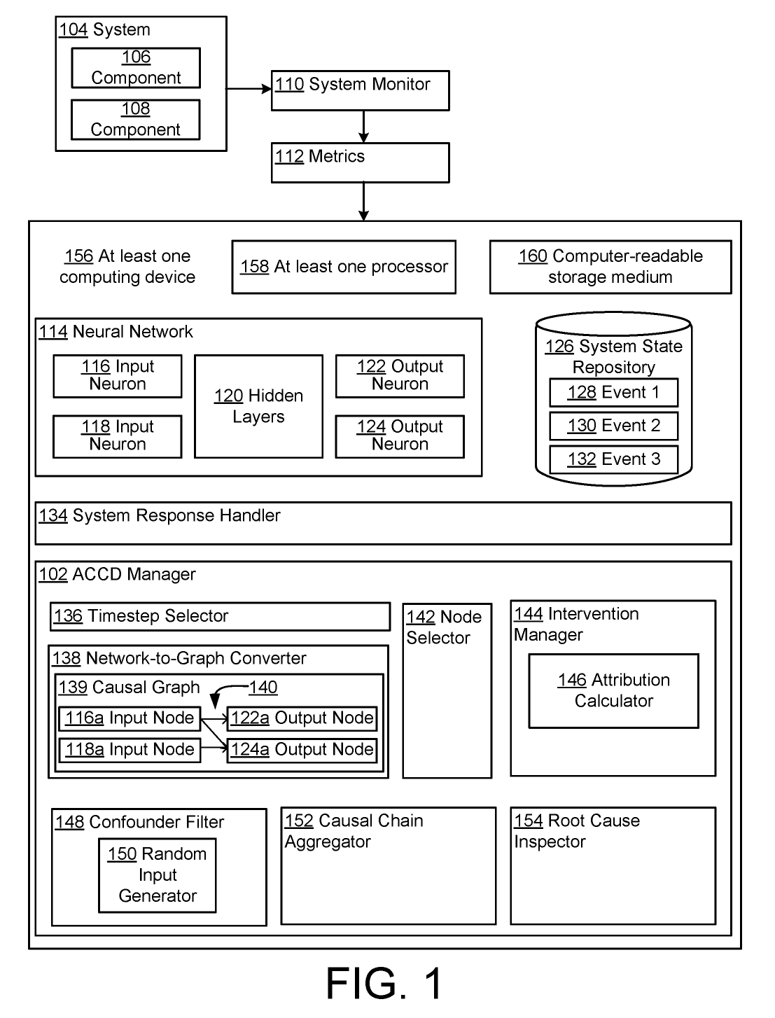

FIG. 1 is a block diagram of a system for sequence prediction explanation using causal chain extraction based on neural network attributions. In the example of FIG. 1, an attribution-based causal chain discovery (ACCD) manager 102 may be configured to provide the types of causal chain extraction and root cause identification referenced above.

For purposes of explaining example functionalities of the ACCD manager 102, FIG. 1 illustrates a system 104 that includes a plurality of components, represented by a component 106 and a component 108. A system monitor 110 may be configured to monitor the system 104 and collect a plurality of metrics 112 characterizing a performance or other operations of the component 106 and the component 108.

In FIG. 1, the metrics 112 may be understood to be a sequence of metrics collected at defined intervals or timesteps. For example, the metrics 112 may be collected every second, every minute, every 10 minutes, every 30 minutes, or every hour.

They system 104 may represent many different types of component-based systems, so that the components 106, 108 may also represent many different types of components. Accordingly, the metrics 112 may represent any types of quantified performance characterizations that may be suitable for specific types of components.

By way of non-limiting examples, the system 104 may represent a computing environment, such as a mainframe computing environment, a distributed server environment, or any computing environment of an enterprise or organization conducting network-based information technology (IT) transactions. The system 104 may include many other types of network environments, such as network administration of a private network of an enterprise.

The system 104 may also represent scenarios in which the components 106, 108 represent various types of sensors, such as internet of things devices (IoT) used to monitor environmental conditions and report on corresponding status information. For example, the system 104 may be used to monitor patients in a healthcare setting, working conditions of manufacturing equipment or other types of machinery in many other industrial settings (including the oil, gas, or energy industry), or working conditions of banking equipment, such as automated transaction machines (ATMs).

Thus, the components 106, 108 should be understood broadly to represent any component that may be used in the above and other types of systems to perform a system-related function, and to provide the metrics 112 using the system monitor 110. In the example of FIG. 1, the system monitor 110 is illustrated as a separate component from the system 104 and the components 106, 108. In various implementations, portions of the system monitor 110 may be implemented within the system 104, or within individual ones of the components 106, 108, and/or the components 106, 108 may be configured to output the metrics 112 directly.

The metrics 112 represent and include performance metrics providing any corresponding type(s) of data that is captured and reported, particularly in an ongoing, dynamic fashion, for any of the above-references types of systems/components, and various other systems, not specifically mentioned here for the sake of brevity. For example, in a setting of online sales or other business transactions, the performance metrics 112 may characterize a condition of many servers being used. In a healthcare setting, the performance metrics 112 may characterize either a condition of patients being monitored or a condition of IoT sensors being used to perform such monitoring. Similarly, the performance metrics 112 may characterize machines being monitored, or IoT sensors performing such monitoring, in manufacturing, industrial, energy, or financial settings. In some examples, which may occur in mainframe, distributed server, or networking environments, the performance metrics 112 may become or include key performance indicators (KPIs).

In FIG. 1, a neural network 114 is configured to process the metrics 112 for a variety of purposes, e.g., related to analyzing and optimizing operations of the system 104. For example, as referenced above, the neural network 114 may represent a RNN.

The neural network 114 may be trained, e.g., using historical metrics data, to provide one or more specific functions with respect to the system 104. For example, the historical metrics data may be labelled with labels of interest to the particular type of system, so that the training of the neural network 114 effectively relates specific historical metrics (and combinations thereof) with corresponding labels.

Then, the trained neural network 114 may be deployed to receive current values of the metrics 112 at each defined timestep (e.g., every minute). The trained neural network 114 may thus, for example, classify the current values with respect to the labels, and/or predict future values of the metrics 112.

In the example of network administration, the system 104 may represent a computer network(s), and the components 106, 108 may represent many types of interconnected network components. For example, such components may include servers, memories, processors, routers, switches, and various other computer or network components. Such components may be hardware or software components, or combinations thereof.

Then, an administrator or other user may wish to identify, classify, describe, or predict various network occurrences or other events. For example, such events may relate to, or describe, different types of optimal or sub-optimal network behavior. For example, network characteristics such as processing speeds, available bandwidth, available memory, or transmission latencies may be evaluated. These and various other characteristics may be related to specific types of network events, such as a crash or a freeze, a memory that reaches capacity, or a resource that becomes inaccessible.

For ease of explanation the below description is provided primarily with respect to the types of network-based examples just given. As may be appreciated from the above description, however, such network examples are non-limiting, and the neural network 114 may be trained to provide similar functionalities in any of the other contexts referenced above (e.g., medical, IoT, manufacturing, or financial), and many other contexts. In fact, a feature of the neural network 114 is its adaptability to many different use case scenarios.

The neural network 114 may be further designed to leverage the sequential nature of the received metrics 112 to improve classification and prediction capabilities of the neural network 114. For example, as referenced above, the neural network 114 may be implemented as a RNN. For example, the neural network 114 may be configured to utilize relationships between the values of the metrics 112 across multiple timesteps, including trends and directions of values of a single metric, or relationships between values of two or more metrics.

In some examples, the neural network 114 may be implemented as a long short-term memory (LSTM) network. Such networks may further leverage scenarios in which metric values across multiple timesteps may have more or less interpretive/predictive power with respect to values at a current or next timestep.

Operations of LSTM networks may be understood with respect to their use in natural language processing, in which a very recent word in a long sentence may tend to have more predictive power with respect to an upcoming word than one of the earlier words in the sentence. In other words, a ‘long term’ variable in the more distant past tends to be less predictive than a more recent ‘short term’ variable.

In specific contexts, however, a long term variable may still have predictive value, while a short term variable may not be dispositive. Therefore, a LSTM network may be trained to quantify an extent to which long and short term variables should be influential in making a current classification or prediction.

In the simplified example of FIG. 1, the neural network 114 includes an input neuron 116, an input neuron 118, hidden layers 120, an output neuron 122, and an output neuron 124. For example, the input neuron 116 may be assigned a value based on a current value of a metric corresponding to the component 106, while the input neuron 118 may be assigned a value based on a current value of a metric corresponding to the component 108.

The hidden layers 120 therefore represent the synapses that connect the input neurons 116, 118 to the output neurons 122, 124 in the neural network architecture. For example, the hidden layers 120 may provide connections between individual ones (or combinations) of the input neurons 116, 118 and the output neurons 122, 124.

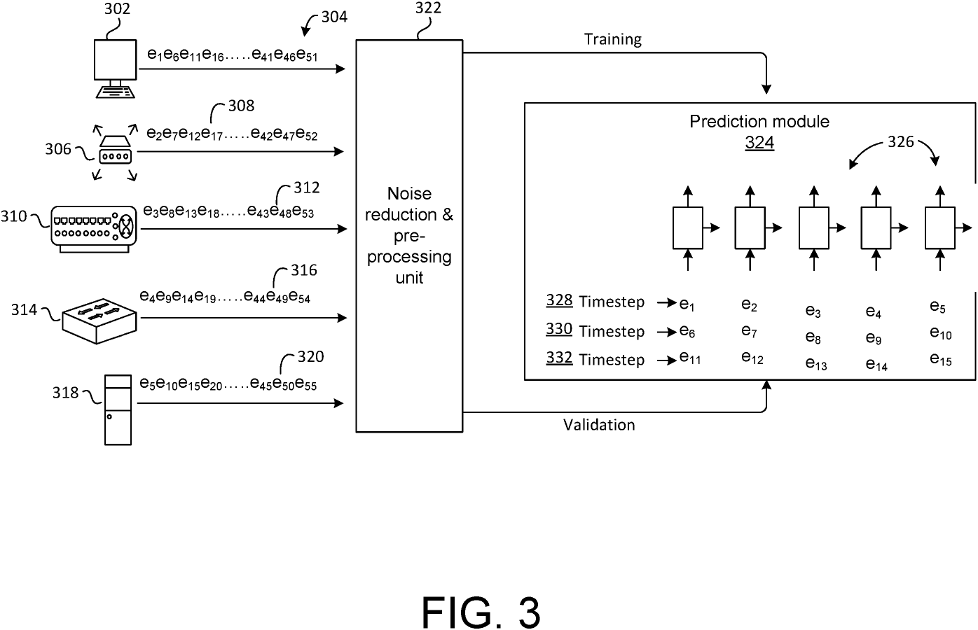

As referenced above, this description of the neural network 114 is highly simplified and generic to many types of neural networks and is included in order to explain operations of the ACCD manager 102. More specific examples and details of the neural network 114 are provided below (e.g., with respect to FIG. 3), and many other implementation details may be selected or included when implementing the ACCD manager 102.

Conventional functionality of the neural network 114 may be, for example, to input current values of the metrics 112 at each timestep (e.g., every minute), and output values of the output neurons 122, 124. These output values may be used to predict future operations of the system 104 and may also be considered in combination with input values of the input neurons 116, 118 at a subsequent timestep. The neural network 114 may also be configured to provide specific classifications of the output neurons 122, 124, as well as predictions of subsequent values of the metrics 112 at a subsequent timestep(s).

Such operations are represented in FIG. 1 by a system state repository 126, which is illustrated as including a first event 128, a second event 130, and a third event 132. That is, the first event 128 may correspond to (occur at) a first timestep at which the neural network 114 is implemented, the second event 130 may correspond to a second timestep at which the neural network 114 is implemented, and the third event 132 may correspond to a third timestep at which the neural network 114 is implemented. In other words, at every timestep, the neural network 114 is applied to the set of metric values received at that timestep, and at least one corresponding output event may be determined.

In this context, the term event should be understood broadly to refer to any output of the neural network 114 that relates to the system 104, which together represent a state of the system 104 over time. For example, an event may be defined with respect to a single output variable (e.g., neuron or metric value), such as a particular memory being 100% full. Thus, multiple events may occur at a single timestep. In other examples, an event may be defined with respect to a plurality or combination of variables, such as when a system crash affects multiple components. Therefore, an event may include one or more values, or may include a classification of one or more values.

In particular examples, a classification may include classification of one or more neural network outputs as being above or below a threshold or score associated with a potential network failure. For example, a memory being 80% full may cause a notification or alert to be generated, so that a response may be implemented to mitigate or avoid system failures.

In FIG. 1, such responses are represented by a system response handler 134. For example, the system response handler 134 may provide one or more graphical user interfaces (GUIs) and associated functionalities, in order to display current or potential system malfunctions, and to enable associated corrections thereof.

In responding to a current or predicted difficulty (e.g., malfunction) in operation of the system 104, however, it is often difficult to determine a cause of the difficulty. Consequently, it is difficult to know how to correct or avoid a problem. Moreover, it is difficult to fully train the neural network 114 with respect to such problems, because doing so using conventional techniques would require actual occurrences of malfunctions of the system 104, which would be impractical and undesirable.

For example, in a network context, a database may have slow response times, which may be caused by a slow disk used to implement the database. The disk may be network-connected and may be slowed by a misconfiguration of a router connected to the disk. Thus, even if the neural network 114 correctly predicts or identifies the slow database, it may be difficult or impossible for a user to identify the misconfigured router as the cause.

In particular, in practical implementations, there may be a large number of metrics 112 and input/output neurons of the neural network 114. Moreover, the neural network 114 may be implemented over a large number of timesteps. Consequently, large volumes of system state data (e.g., events) may be generated over time, and there may be many different relationships (e.g., causations and correlations) between and among the events.

In FIG. 1, the ACCD manager 102 enables extraction of causal chains of dependencies between multiple events across multiple timesteps. The causal chains may be merged into a single causal chain for an event being investigated, and a root cause of the investigated event may be identified with a high degree of accuracy. Accordingly, the system response handler 134 may be used to correct or mitigate the investigated event, and similar events may be avoided more successfully in the future.

In more detail, the ACCD manager 102 may be configured to select an event to be investigated, represented in FIG. 1 by the third event 132. As referenced above, the third event 132 may represent an event such as a slow database. The ACCD 102 may then work backwards in time to a preceding event, e.g., the second event 130, to determine a causal relationship between the events 130, 132 (if any). The ACCD manager 102 may continue to work backwards in time to the first event 128, to determine if a causal relationship exists between the first event 128 and the second event 130, or between the first event 128 and the third event 132.

In FIG. 1, as described below, the events 128, 130, 132 need not happen in consecutive or adjacent timesteps. That is, intervening events may occur that are not illustrated in FIG. 1, and which do not have a (significant) causal effect on the event being investigated. For example, over ten timesteps 1-10, the third event 132 may occur at timestep 10, the second event 130 may occur at timestep 5, and the first event 128 may occur at timestep 1. Thus, an event may have a causal effect on a later, non-successive or non-consecutive event, such as when the first event 128 has a direct causal effect on the third event 132 (whether the intervening second event 130 has a causal effect or not), or when the second event 130 has a causal effect on the third event 132 notwithstanding unillustrated intervening events.

The ACCD manager 102 may be configured to identify such causal dependencies across multiple timesteps and for multiple variables and events, to thereby extract a single causal chain for an event being investigated. Once the causal chain is extracted, root cause analysis may be performed to identify an actual root cause of the event being investigated.

In the example of FIG. 1, the ACCD manager 102 is illustrated as including a timestep selector 136. The timestep selector 136 may be configured to make an initial selection of an event to be investigated at a selected timestep and may also be configured to select preceding timesteps, as the ACCD manager 102 investigates backwards in time across multiple timesteps to extract a causal chain of events leading forward in time to the selected, investigated event.

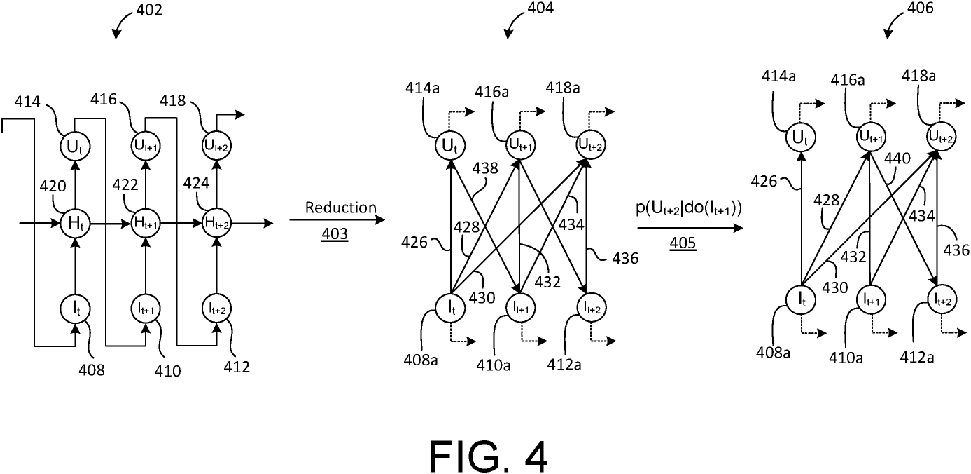

At the selected timestep, a network-to-graph converter 138 may be configured to convert the neural network 114 into a causal graph 139, such as a structural causal model. As referenced above, and illustrated and described in detail, below, e.g., with respect to FIG. 4, the resulting causal graph 139 may include input node 116a, corresponding to the input neuron 116, and input node 118a, corresponding to the input neuron 118. Similarly, the resulting causal graph 139 may include output node 122a, corresponding to the output neuron 122, and output node 124a, corresponding to the output neuron 124. In other words, the causal graph 139 represents a simplified, marginalized, or lossy version of the neural network 114, in which the input/output neurons are represented as graph nodes, the hidden layers 120 are removed, and potential causal relationships between the input nodes 116a, 118a and the output nodes 122a, 124a are determined.

In the simplified example of FIG. 1, the causal graph 139 includes simplified examples of links or edges 140 representing potential causal relationships. In general, it may be possible that any input node may causally affect any output node, including potentially affecting multiple output nodes.

As is typical for neural networks such as the neural network 114, the hidden layers 120, as a result of the training of the neural network 114, may be used during operation of the neural network 114 to determine values of the output neurons 122, 124 for values of input neurons 116, 118 for the timestep in question, corresponding to the values of the metrics 112 at that timestep. In contrast, the causal graph 139 may be used by a node selector 142 and an intervention manager 144 to characterize and quantize a causal effect of each input node 116a, 118a on each output node 122a, 124a.

For example, the node selector 142 may select the output node 122a and the intervention manager 144 may characterize a causal effect of the input node 116a thereon. The node selector 142 may select the output node 124a and the intervention manager 144 may characterize a causal effect of each of the input node 116a and the input node 118a thereon.

For example, the intervention manager 144 may include an attribution calculator 146 that may be configured to calculate an average causal effect (ACE) of the input node 116a on the output neuron 122a, of the input node 116a on the output neuron 124a, and of the input node 118a on the output node 124a, using the determined links 140 of the causal graph 139. In other words, the calculated attributions characterize extents of causal effects between input/output node pairs, using a common scale or range, so that such causal effects can be meaningfully compared across multiple types of node pairs and underlying metrics 112. For example, the attribution calculator 146 may normalize calculated causal effect scores within a range such as 0 to 1, or between 1 to 100, which may then be assigned to each of the edges 140.

In example implementations, at a given timestep, the node selector 142 may select an output node for intervention testing. For example, a node may be selected based on an indication of a user that a related event should be investigated. In other examples, as described below, a node may be selected based on results of intervention testing of an earlier-tested timestep. In some scenarios, all output nodes at a currently-tested timestep may be selected for interventional testing.

For example, node selector 142 may select the output node 122a for intervention testing. Then, the intervention manager 144 may perform intervention testing by applying hypothetical input values for relevant input nodes. For example, in FIG. 1, the causal graph 139 indicates that the output node 122a may be causally affected by the input node 116a, but not by the input node 118a.

The intervention manager 144 may then apply hypothetical input values at the input neuron 116 of the neural network 114 to obtain corresponding output values at the output neuron 122. The attribution calculator 146 may use resulting output values at the output neuron 122 for comparison against baseline output values, so that the difference therebetween represents an extent of causal effect of the tested input node 116a on the tested output node 122a. For example, as referenced above and described in more detail, below, the attribution calculator 146 may calculate an ACE value that averages the causal effects across the range of input values tested.

If the node selector 142 then selects the output node 124a for intervention testing, the intervention manager 144 may be required to perform intervention testing on both the input nodes 116a, 118a, since the edges 140 indicate that the output node 124a may be causally affected by either or both of the input nodes 116a, 118a. Accordingly, the intervention manager 144 may first hold an input value for the node 116a (i.e., at the neuron 116) constant while performing intervention testing for the input node 118a (using the input neuron 118). Then, conversely, the intervention manager 144 may hold an input value of the input node 118a constant while performing intervention testing for the input node 116a.

In other words, the intervention manager 144 may individually test causal effects on individual output nodes by isolating corresponding, individual input nodes for intervention testing, including holding values for non-tested input nodes constant and providing hypothetical intervention test values to a corresponding input neuron of an input node being tested. In this way, the attribution calculator 146 may calculate an ACE (or other measure of attribution) for each individual pair of input/output nodes.

The intervention manager 144 may also assign a minimum attribution threshold value, e.g., a minimum ACE value or strength, required to retain a tested edge of the edges 140. That is, the intervention manager 144 may assign an ACE value to each edge of the edges 140, and then may retain only those edges having an ACE value higher than a pre-defined threshold. Put another way, the intervention manager 144 may delete individual ones of the edges 140 that receive ACE values from the attribution calculator 146 that are lower than a threshold ACE value.

Once all output nodes have been tested, the timestep selector 136 may select a next timestep for testing. As described above, the next-tested timestep may be a preceding timestep of the timestep just tested, as the ACCD manager 102 works backwards in time to find a cause of an investigated event.

For example, at a preceding timestep, the node selector 142 may again select an initial node for testing. In some scenarios, the node selector 142 may use the same causal graph 139, or the network-to-graph converter 138 may determine a modified causal graph. For example, it could occur that no input values are received at the input neuron 116, so that the input node 116a is omitted.

As referenced above, the node selector 142 may proceed to select output nodes for intervention testing by the intervention manager 144. As also referenced, the node selector 142 may select output nodes for testing based on results of intervention testing performed at the earlier-tested (i.e., later in time) timestep. In this way, exhaustive testing of all output nodes is not required.

Operations of the timestep selector 136, the node selector 142, and the intervention manager 144 may proceed iteratively to a next-preceding timestep(s). As referenced above, the intervention manager 144 may perform intervention testing between node pairs at each timestep, as well as between node pairs across one or more timesteps, so as to identify causal effects that occur across timesteps.

To illustrate this point in a simplified example from the realm of NLP, the neural network 114 might represent a LSTM network trained to predict a subsequent word in a sentence (with each word considered to be spoken at an individual timestep). In a sentence such as “The man from Germany speaks German,” the word “Germany” may have a high causal effect on the word “German,” even though there is an intervening word “speaks” (which may also have a causal effect on the word “German”).

Likewise, in FIG. 1, the first event 128 may have a causal effect on the third event 132, even though the first event 128 and third event 132 are separated by at least one timestep at which the second event 130 occurs. For example, in an IT scenario, the first event 128 may relate to high processor usage, which may cause a full memory as the third event 132.

Therefore, the timestep selector 136, the node selector 142, and the intervention manager 144 may determine causal effects at each timestep, between pairs of consecutive timesteps, and across intervening timesteps. As referenced, however, exhaustive testing across all nodes of all timesteps is not required. Instead, a greedy search may be performed by removing individual edges of the edges 140 that are below an ACE threshold, and then only testing nodes linked by remaining edges. Moreover, testing of various node pairs may proceed in parallel to further enhance a speed of operations of the ACCD manager 102.

Intervention testing may continue, for example, until a designated number (depth) of timesteps is reached. For example, the timestep selector 136 may be configured to iteratively select a maximum of 4, 5, or more preceding timesteps. Additionally, or alternatively, intervention testing may continue until no (or a sufficiently small number of) edges are found with ACE scores above the assigned attribution threshold.

As a result of the above-described operations of the ACCD manager 102, a number of causal chains of nodes across multiple timesteps may be obtained. A confounder filter 148 may be configured to analyze some or all of the retained causal edges having attribution scores above the assigned attribution threshold, to identify and remove nodes (and corresponding edges) representing confounder variables instead of the desired causal variables.

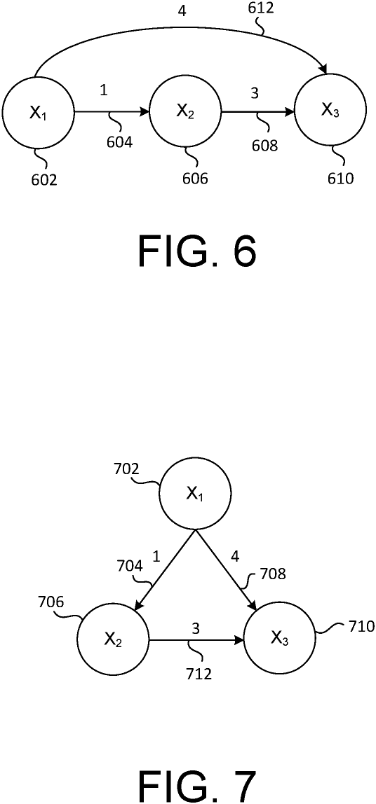

That is, as referenced above, and as described in more detail below with respect to FIGS. 6, 7, and 9, a confounder variable or node is one that causes (has a causal effect on) at least two other variables/nodes, and thereby causes the (at least) two affected nodes to appear to be also causally related, when in fact the two affected nodes are merely correlated by virtue of a confounder.

To identify a confounder and remove confounder (correlation) edges, the confounder filter 148 may be configured to perform a chronologicity test. For example, a chronologicity test may be performed that hypothetically and randomly changes an order of occurrence of values of at least one preceding variable, and then determines whether a confounder exists based on output values obtained using the re-ordered values.

For example, in the context of the types of IT scenarios referenced above, a random input generator 150 may be configured to generate random permutations of preceding values of potential confounder nodes/variables being tested. Then, previously-determined causal edges that were included in a causal chain by the intervention manager 144 may be removed if the causal effects are substantially unchanged, or may be retained if the chronologicity test reveals a substantial difference when using the randomly-permuted values. As explained in detail, below, such an approach is based on the observation that, particularly in a LSTM context, an order of causal values will affect predictions of the neural network being used, so that changing an order of such values is likely to cause a subsequent network prediction to be less accurate.

Following operations of the confounder filter 148, a number of causal chains across multiple nodes and timesteps may have been obtained. A causal chain aggregator 152 may be configured to merge or join all obtained causal chains. Accordingly, a single causal chain for each investigated event may be obtained.

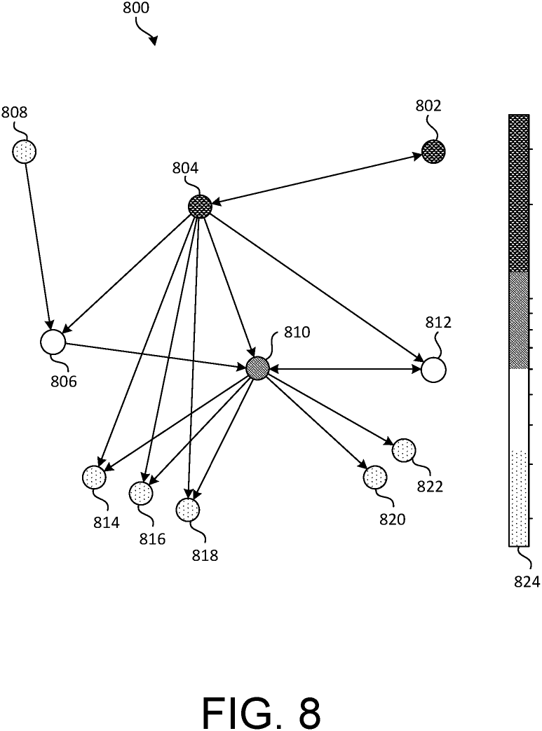

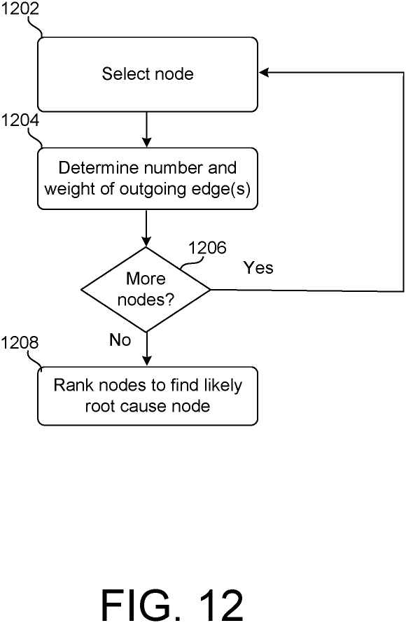

Then, a root cause inspector 154 may be configured to analyze the aggregated causal chain and to determine a root cause node that was the cause of the investigated event. For example, a network centrality algorithm may be used that ranks nodes based on factors such as number of outgoing causal edges, total number of outgoing edges along one or more causal chains of the aggregated causal chain, and/or values of attribution scores between node pairs. FIG. 8 illustrates an example heat map that may be constructed using these or similar factors to rank root causes for a root cause analysis, and FIG. 12 illustrates a more detailed example of the root cause analysis ranking that may be implemented by the root cause inspector 154.

In FIG. 1, the ACCD manager 102 is illustrated as being implemented using at least one computing device 156, including at least one processor 158, and a non-transitory computer-readable storage medium 160. That is, the non-transitory computer-readable storage medium 160 may store instructions that, when executed by the at least one processor 158, cause the at least one computing device 156 to provide the functionalities of the ACCD manager 102 and related functionalities.

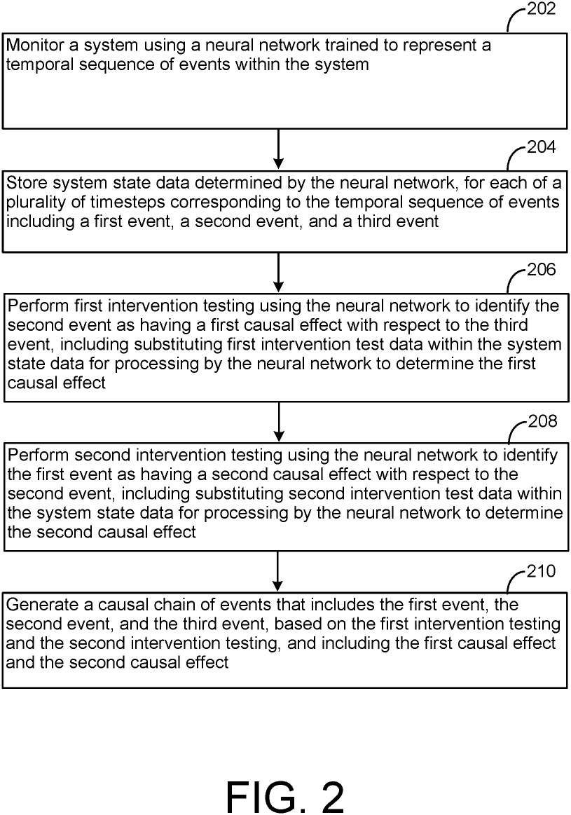

FIG. 2 is a flowchart illustrating example operations of the system 104 of FIG. 1. In the example of FIG. 2, operations 202-210 are illustrated as separate, sequential operations. In various implementations, the operations 202-210 may include sub-operations, may be performed in a different order, may include alternative or additional operations, or may omit one or more operations. Further, in all such implementations, included operations may be performed in an iterative, looped, nested, or branched fashion.

In FIG. 2, a system 104 may be monitored using a neural network 114 trained to represent a temporal sequence of events within the system 104 (202). For example, the neural network 114 of FIG. 1 may be trained to represent sequences of events in the system 104. As described above, an event may include, for example, a single input or output of one or more of the components 106, 108, or a combination of two or more inputs or outputs of the components 106, 108. An event may include any function or malfunction of one or more of the components 106, 108. As also described, events may be captured or characterized using the metrics 112. The neural network 114 may be trained using historical data of the system 104, such as historical metrics and historical events.

System state data determined by the neural network 114 may be stored, for each of a plurality of timesteps corresponding to the temporal sequence of events including a first event 128, a second event 130, and a third event 132 (204). For example, in FIG. 1, the neural network 114 may store system state data in the system state repository 126, including the first event 128, the second event 130, and the third event 132. As also described, the first event 128, the second event 130, and the third event 132 need not occur consecutively across adjacent timesteps, but may occur across four or more timesteps. Two or more events may also occur at a single timestep. Of course, the first event 128, the second event 130, and the third event 132 are representative, and many thousands, millions, or more events may be stored in the system state repository 126.

First intervention testing may be performed using the neural network 114 to identify the second event 130 as having a first causal effect with respect to the third event 132, including substituting first intervention test data within the system state data for processing by the neural network 114 to determine the first causal effect (206). For example, upon receipt of the third event 132 as an event to be investigated, e.g., for root cause analysis, the intervention manager 144 may be used to perform the first intervention testing using the causal graph 139, such as a structural causal model (SCM). For example, the third event 132 may occur at the output node 124a, and the intervention manager 144 may perform the first intervention testing with respect to the input node 116a and the input node 118a.

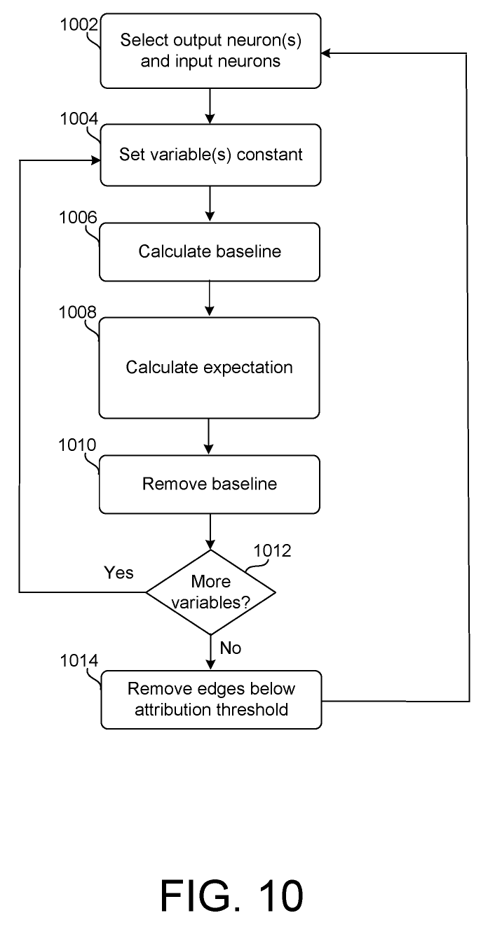

As described herein, intervention testing refers to experimental, hypothetical, or ‘what if’ testing techniques, in which intervention test data is generated by the intervention manager 144 and substituted for corresponding, actual system data of the system 104. Intervention testing is described in detail, below, with respect to FIGS. 4 and 10, through the use of an operator referred to as a ‘do’ operator. As described, the ‘do’ operator represents what would happen if a component(s) were to do a particular thing, such as provide a particular output.

For example, if the third event 132 represents a component crash, and the second event 130 represents a temperature metric that is above a threshold (related to overheating), intervention test data may refer to hypothetical temperature values that may be substituted for the actual temperature value of the second event 130. Values of intervention test data may be selected using various techniques. For example, the intervention manager 144 may generate intervention test data values that are minimally changed from an actual value, while still being sufficient to cause the observed subsequent event. In other scenarios, the intervention test data values may be generated randomly within a range, or using any algorithm appropriate to generate the type of intervention test data required.

If the third event 132 is associated with the output node 124a in FIG. 1, and the input node 116a represents temperature values, then the intervention testing may include holding any values provided by the input node 118a constant throughout the intervention testing. Subsequently, values of the input node 118a may be varied while the temperature value of the input node 116a is held constant.

Accordingly, the attribution calculator 146 may calculate an attribution representing a causal effect of each input node 116a, 118a on the output node 124a. For example, when attribution is represented using the ACE, the attribution calculator 146 may determine an average of causal effects that occur for each instance of intervention test data. Accordingly, any edges of the edges 140 associated with an ACE value above an attribution threshold may be retained, while any edges below the attribution threshold may be deleted.

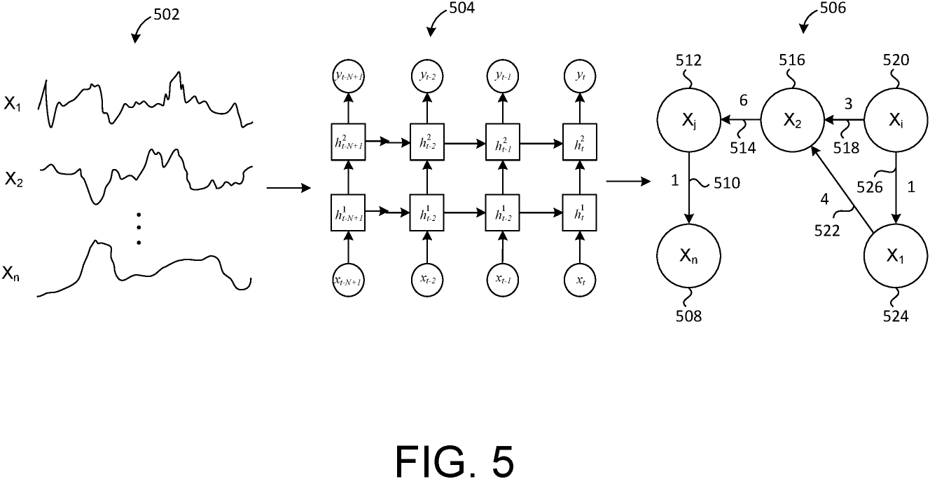

Second intervention testing may be performed using the neural network 114 to identify the first event 128 as having a second causal effect with respect to the second event 130, including substituting second intervention test data within the system state data for processing by the neural network 114 to determine the second causal effect (208). For example, the intervention manager 144 and the attribution calculator 146 may repeat the above-described processes with respect to a preceding timestep of the system state data, which is not illustrated explicitly in FIG. 1, but is described and illustrated below, e.g., with respect to FIG. 5.

In the present description, by way of terminology, the terms first, second, third may refer to an order of occurrence of actual events within the system 104, such as the first event 128, the second event 130, and the third event 132. However, as described, the system of FIG. 1 operates to discover causal effects between such events working backwards in time, starting from a point in time at which an event to be investigated occurs. Accordingly, for ease of reference, the terms first, second, third may also be used to describe an order in which such causal effects are determined. For example, in the above examples, the referenced first causal effect refers to a first-discovered causal effect when operating the system of FIG. 1, and the referenced second causal effect refers to a second-discovered causal effect when operating the system of FIG. 1, even though the original temporal sequence of the referenced effects, including the second causal effect happening prior to the first causal effect.

A causal chain of events that includes the first event 128, the second event, 130, and the third event 132 may be generated, based on the first intervention testing and the second intervention testing, and including the first causal effect and the second causal effect (210). For example, the causal chain aggregator 152 may be configured to generate the causal chain as a graph that includes a plurality of nodes corresponding to the included, represented events, ACE scores assigned to each edge 140 or node pair, and a number of timesteps between each connected node pair of the causal chain.

Although not illustrated explicitly in FIG. 2, the confounder filter 148 may be used to modify the causal chain by removing confounder nodes. If the determined causal chain is one of two or more causal chains extracted with respect to the third event 132, then confounder filtering may occur prior to or after aggregation of the two or more causal chains into a merged causal chain provided by the causal chain aggregator 152.

Further, the root cause inspector 152 may be used to analyze the resulting causal chain, to determine a root cause of the investigated event, e.g., the third event 132. For example, as described, the root cause inspector 152 may perform graph analysis of the causal chain to determine a node that is statistically most likely to be the root cause node.

FIG. 3 is a block diagram illustrating an example system in which the system of FIG. 1 may be used. As shown, FIG. 3 illustrates a specific example of the type of IT scenarios referenced above.

In the example of FIG. 3, a component 302 outputs a first metric time series 304, a component 306 outputs a second metric time series 308, a component 310 outputs a third metric time series 312, a component 314 outputs a fourth metric time series 316, and a component 318 outputs a fifth metric time series 320. As illustrated, the various example components 302, 306, 310, 314, 318 together represent an IT system corresponding to the system 104 of FIG. 1, and may individually represent any suitable IT component, such as a computer, a mainframe, a router, a switch, a hub, or a server, corresponding to the components 106, 108 of FIG. 1.

Thus, FIG. 3 illustrates that multivariant time series may be treated by a noise reduction and pre-processing unit 322, and then input to a prediction module 324 corresponding to the neural network 114 of FIG. 1. The prediction module 324 may represent a deep learning RNN model using a LSTM architecture, as referenced above, and may undergo suitable training and validation prior to being deployed.

The prediction module 324 may thus include a plurality of LSTM cells 326. Although not shown in detail in FIG. 3, such LSTM cells 326 may include standard LSTM implementation features and techniques, such as an input gate, an output gate, a hidden gate, a cell, and a forget gate.

FIG. 3 illustrates that a value of each of the metric time series 304, 308, 312, 316, 320 may be received at sequential timesteps. As shown, a timestep 328 may include values e₁, e₂, e₃, e₄, e₅, while a timestep 330 includes values e₆, e₇, e₈, e₉, e₁₀, and a timestep 332 includes values e₁₁, e₁₂, e₁₃, e₁₄, e₁₅.

Thus, FIG. 3 illustrates an example of an architecture for a Deep Learning RNN model for which sequence prediction interpretability may be provided. The prediction module 324 takes the metric time series 304, 308, 312, 316, 320 from various network components 302, 306, 310, 314, 318, respectively, as input to an LSTM model to predict future events.

For example, the multivariate time series model of FIG. 3 may be aimed at lowering network unavailability and increasing network stability, by proactively predicting the failures, such as network outages and network backbone failures. The prediction module 324 may be configured to predict a network failure within a subsequent time step successfully, but does not provide information regarding why the network failure prediction occurred. That is, the prediction module 324, by itself, does not identify specific inputs that resulted in the predicted network failure, or interpret the network failure prediction, or suggest a specific action to avoid the predicted network failure.

FIG. 4 is a diagram illustrating graph conversion of a neural network for intervention testing. FIG. 4 illustrates a neural network 402 as an example of the neural network 114 of FIG. 1 (or of the prediction module 324 of FIG. 3), which may undergo reduction 403 to obtain a SCM 404 as an example of the causal graph 139 of FIG. 1. The SCM 404 may then undergo intervention testing 405 to obtain an example SCM instance 406 of the SCM 404 used to assign attribution scores, e.g., ACE values.

In more detail, the neural network 402 includes input neurons 408, 410, 412, which correspond to the input neurons 116, 118 of FIG. 1. The neural network 402 includes hidden layer cells 420, 422, 424, which correspond to the hidden layer 120 of FIG. 1. The neural network 402 also includes output neurons 414, 416, 418, which correspond to the output neurons 122, 124 of FIG. 1. In FIG. 4, by way of terminology, “I” is used to refer to the various inputs, “H” is used to refer to a hidden layer(s), and “U” is used to refer to the various outputs. Further, “t” is used to refer to timesteps, so that “t” refers to a first timestep, “t+1” refers to a second, subsequent timestep in chronological order, and “t+2” refers to a third, subsequent timestep in chronological order.

The reduction 403 represents an example of operations of the network-to-graph converter 138 of FIG. 1. Consequently, the SCM 404 includes input nodes 408a, 410a, 412a corresponding to the input nodes 116a, 118a, output nodes 414a, 416a, 418a corresponding to the output nodes 122a, 124a, and various edges 426, 428, 430, 432, 434, 436, and 438, corresponding to the edges 140 of FIG. 1.

In more detail, the neural network 402 may represent a hidden layer unfolded recurrent model in which outputs are used as inputs for the next time step. Using the terminology of FIG. 4, for example, in the neural network 402, vertex Ht+1 (422) causes Ut+1 (416), i.e., and a functional dependence exists therebetween.

The reduction 403 may be implemented as a marginalization process in which the hidden layer neurons 420, 422, 424 are removed. For example, if Hₜ₊ᵢ (422) is marginalized out, its parents Iₜ₊ᵢ (410) and Hₜ (420) become the causes (parents) of Uₜ₊ᵢ (416). Similarly, if Hₜ (420) is marginalized out, both Iₜ (408) and Iₜ₊ᵢ (410) become causes of Uₜ₊ᵢ (416). Similar reasoning and techniques may be employed for a remainder of the neural network 402 to obtain the reduced (marginalized) SCM 404.

Then, intervention testing may be performed on the SCM 404 using the ‘do’ operator, which may also be referred to as ‘do calculus,’ to determine an ACE of each of the edges 426-438. As referenced above, ACE measures the causal effect of a particular input neuron on a particular output neuron of the network, using an interventional expectation compared to a baseline. Therefore, ACE may be expressed as being calculated as an attribution for feature xᵢ for output y using the equation:

$$A C {E}_{\text{do} \left(\text{xi=} α\right)}^{y} = E \left[y \left|d o \left({x}_{i} = α\right)\right)\right] - b a s e l i n {e}_{x i ,}$$

in which E[y|do(xi=α)] is obtained by performing an intervention on a recurrent network.

FIG. 5 is a diagram illustrating extraction of causal chain for the examples of FIGS. 1-4. In FIG. 5, multivariate input streams 502, corresponding to the examples 304, 308, 312, 316, 320 of FIG. 3 and metrics 112 of FIG. 1, are received at a neural network 504. The neural network 504 corresponds to the neural network 114 of FIG. 1, prediction module 324 of FIG. 3, and neural network 402 of FIG. 4.

Further in FIG. 5, a causal chain 506 illustrates an example output of the causal chain aggregator 152 of FIG. 1, following completion of intervention testing as described with respect to FIGS. 1-4 across multiple timesteps. In FIG. 5, the causal chain 506 includes a node 508 connected by an edge 510 to a node 512, which is connected by an edge 514 to a node 516. The node 516 is connected by an edge 518 to a node 520, and by an edge 522 to a node 524. The node 524 is connected to the node 520 by an edge 526.

In FIG. 5, the various edges thus represent retained edges of edges corresponding conceptually to the edges 140 of FIG. 1, calculated across multiple timesteps. The relevant timesteps across which calculations are made are also illustrated in FIG. 5, with respect to each edge. For example, the edge 510 is marked with a 1, indicating that the node 512 is separated in time from the node 508 by 1 timestep. That is, the node 512 occurs at a preceding timestep prior to the node 508, e.g., one minute earlier when the timestep is a single minute.

Similarly, the edge 514 is marked with a 6, indicating that the node 516 occurs six timesteps prior to the node 512. In other words, in the example, when providing intervention testing for the node 512, the intervention manager 144 was required to proceed backwards in time for six timesteps before finding a sufficiently strong ACE value (i.e., an ACE value above an attribution threshold). Similar comments apply to the edge 518 (illustrating that the node 520 occurs three timesteps prior to the node 516), the edge 522 (illustrating that the node 524 occurs four timesteps prior to the node 516), and the edge 526 (illustrating that the node 520 occurs one timestep prior to the node 524).

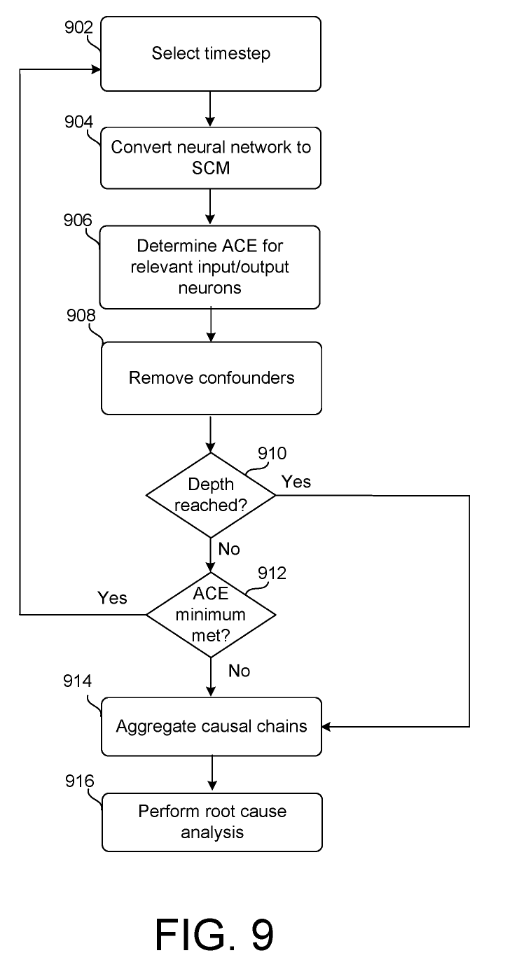

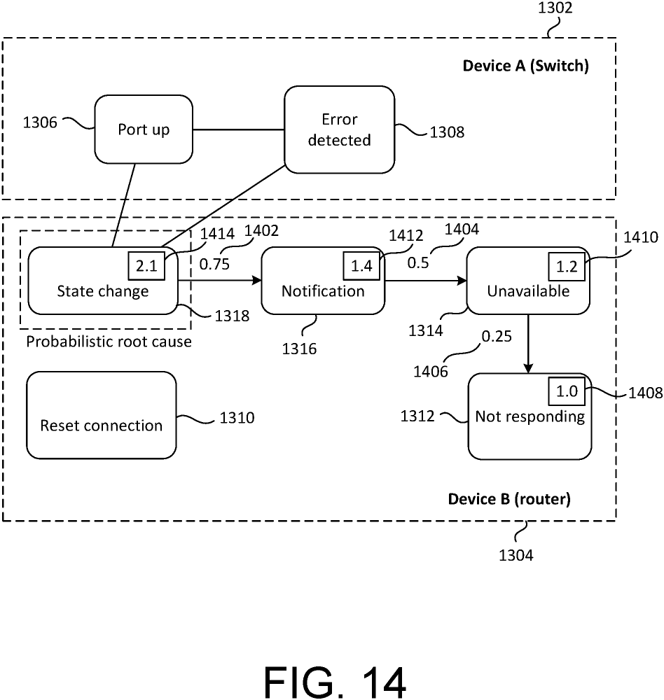

As described above, and in more example detail below, with respect to FIG. 9, the causal chain 506 may be extracted using a parallelizable greedy search procedure that works backwards in time from an event to be investigated (e.g., an event corresponding to the node 508 in FIG. 5), using a SCM at each timestep to determine or select inputs on which to perform intervention testing, and retaining tested edges (or not) based on a strength of the resulting, calculated ACE scores. For example, the edges 510, 514, 518, 522, and 526 may also be demonstrated with their respective ACE scores, as discussed in relation to FIG. 14.

As described with respect to the causal chain aggregator 152 of FIG. 1, the causal chain 506 may represent a merged causal chain that has been aggregated from multiple, parallel causal chain extractions performed using the neural network 504 across multiple timesteps at which individual metrics of the multivariate time series 502 were received. Further with reference back to specific components of the example ACCD manager 102 of FIG. 1, the causal chain 506 may be examined by the confounder filter 148 to remove potential confounders, as described with respect to FIGS. 6, 7, and 11, and by the root cause inspector 154 to identify a root cause node (e.g., the node 520), as described with respect to FIGS. 8 and 12.

Specifically, FIG. 6 is a graph illustrating a first example of a potential confounder variable, and FIG. 7 is a graph illustrating a second example of a potential confounder variable. In FIG. 6, a node 602 is connected by an edge 604 to a node 606, which is connected by an edge 608 to a node 610. The node 602 is also connected by an edge 612 to the node 610. In FIG. 7, a node 702 is connected by an edge 704 to a node 706, and by an edge 708 that is connected to a node 710. The node 706 is also connected by an edge 712 to the node 710.

FIGS. 6 and 7 illustrate that seemingly similar relationships between nodes may actually be substantively different for purposes of constructing the causal chain 506 of FIG. 5. For example, in FIG. 5, the nodes 516, 520, 524 (and corresponding edges 518, 522, 526) illustrate a similar structure to the examples of FIGS. 6 and 7.

In the example of FIG. 6, the node 602 may directly cause (may have a causal relationship with) the node 606 with a delay of one timestep, and may indirectly cause the event of the node 610 with a total delay of 1+3 = 4 timesteps (corresponding to the edge 612). In FIG. 7, however, the node 702 is a confounder of the nodes 706, 710, and the edge 712 represents a correlation between the nodes 706, 710 and not an actual causal relationship. Consequently, the edge 712 may be removed (filtered) by operation of the confounder filter 148.

Identifying a confounder as a common cause of multiple variables has historically been difficult, because, for example, confounder effects may be correlated (as with the nodes 706, 710 and the edge 712 in FIG. 7). Such difficulties may be increased when there may be delays between affected variables from confounders.

To identify confounders for filtering, the confounder filter 148 of FIG. 1 may measure a randomized ACE score(s) of a variable (node) to identify whether that variable has a direct causal effect, or has a correlated effect through an intermediate variable because of a confounder effect. For example, with respect to FIG. 7, the intervention manager 144 may determine that both the nodes 702, 706 are potential causes for X3, based on the calculated average causal effect scores of the edges 708 and 712. The confounder filter 148 may implement a chronologicity test to check whether these causes are true causes of X3.

For example, when values of X1 are randomly permuted to predict X3, the randomized intervention ACE_{I} will be likely to be lower than the actual ACE, because the neural network used for testing would have no access to a chronological order of the values of the potential confounder X1. On the other hand, if the chronologicity check is applied to X2, the ACE probably will not vary significantly, because the neural network used for testing would still have access to the chronological order of the values of the potential confounder X1 to predict X3. Then, the confounder filter 148 may determine that the node 702 represents a true cause of the node 710 and retain the edge 708.

In more detail, the random input generator 150 of FIG. 1 may be used to change a permutation or order of preceding values of a variable/node being tested as a potential confounder. In other words, permutation importance may be used as a chronologicity check (CC), where permutation feature importance may be defined as a decrease in a model score when a single variable value is randomly shuffled. That is, permuting time series values removes chronologicity and therefore breaks a possible causal relationship between cause and effect. Consequently, a tested variable may be determined to demonstrate a causal effect only if the ACE of the variable decreases significantly when the variable is permuted.

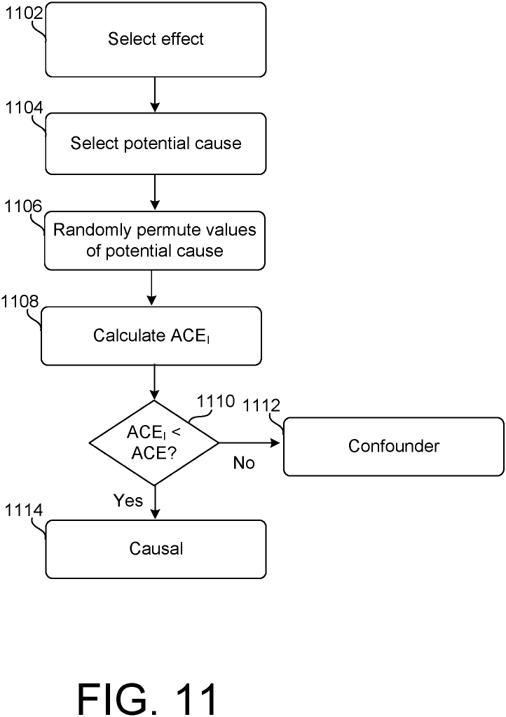

Therefore, to test for confounders (or validate a potential cause), the confounder filter 148 may create a randomized, intervened dataset for each potential cause Yₘ ∈ Pₙ. Such an approach is conceptually similar to the intervention testing of the intervention manager 144, but values of a possible cause variable timestep Yₘ ∈ Pₙ are randomly permuted (i.e., changed in order or sequence). Since random permutations do not alter the distribution of the dataset, the neural network does not have to be retrained. Additional example details of confounder filtering are provided below, with respect to FIG. 11.

FIG. 8 is a graph 800 illustrating an example node ranking for root cause analysis. In FIG. 8, the graph 800 includes a number of nodes 802, 804, 806, 808, 810, 812, 814, 816, 818, 820, and 822, which are ranked according to a heat map 824 to indicate relative order of importance as potential root cause nodes. That is, nodes appearing closer to an upper right portion of FIG. 8 may be more likely to be considered a root cause node, while nodes appearing farther from an upper right portion of FIG. 8 may be less likely to be considered a root cause node. Of course, many different techniques may be used to calculate and illustrate a likelihood that a node is a root cause node, and FIG. 8 provides merely one such example.

It will be appreciated from the above description of the causal chain 506 of FIG. 5 that the graph 800 effectively represents a similar causal chain in which individual nodes have been ranked, ordered, and positioned according to the heat map 824. Therefore, although not separately enumerated, the various edges of FIG. 8 should be understood to be associated with both timesteps between node pairs, as well as ACE scores between node pairs.

As referenced, multiple approaches may be used to rank and order the various nodes 802-822 with respect to the heatmap 824. In general, the example of FIG. 8 illustrates that each node may be evaluated as a potential root cause node based on a number and an importance of outgoing edges from the evaluated node.

In other words, for example, a node that has a large number of outgoing edges may be relatively likely to be a root cause node. More specifically, a node may be evaluated for a number of outgoing edges by counting a total number of outgoing edges across all subsequent nodes, until final or leaf nodes are reached. For example, the node 810 is illustrated as having five outgoing edges, but the preceding node 804 may be counted as having the same five edges, plus additional outgoing edges to the nodes 806, the node 810, and the node 812. Similarly, the node 802 has only a single direct outgoing edge to the node 804, but may be evaluated as having indirect edges that include all of the direct and indirect edges of the node 804. Consequently, as shown, the node 804 is higher in the heat map 824 than the node 810, and the node 802 is higher than the node 804.

Additionally, a node having an edge with an ACE score that is relatively very high may be relatively more likely to be a root cause node than an edge with a lower ACE score. In other words, each edge of the graph 800 may be considered to be weighted with a corresponding ACE score, with higher weights being more likely to cause the connected nodes to be placed higher on the heat map 824.

Of course, the root cause inspector 154 may use combinations of these and other techniques to evaluate the graph 800 to determine a root cause node. More specific examples of such techniques are provided below, with respect to FIG. 12.

FIG. 9 is a flowchart illustrating more detailed examples of the flowchart of FIG. 2, including example operations of the ACCD manager 102. In the example of FIG. 9, a user (e.g., administrator, tester, or investigator) may wish to investigate an event, such as the third event 132. As may be appreciated from the above, the third event 132 may represent an event that has already happened, such as a system freeze or crash, a memory overflow, or any type of malfunction or undesired behavior. In other examples, the third event 132 may be an event that is predicted by the neural network 114 (e.g., RNN, LSTM) to occur in the future, so that operations of the ACCD manager 102 may enable avoidance of actual occurrence of the predicted event.

Thus, in FIG. 9, a timestep may be selected (902) that corresponds to the investigated third event 132, i.e., the timestep at which the investigated third event 132 has occurred, or is predicted to occur. In the example of FIG. 5, the node 508 Xₙ may represent or correspond to an investigated event. With reference to FIG. 1, the timestep selector 136 may be used to select the investigated event. For example, a suitable graphical user interface (GUI) may be provided to enable event/timestep selection.

A neural network used to monitor and predict the investigated event may be converted into a structural causal model (SCM) (904). For example, the network-to-graph converter 138 of FIG. 1 may convert the neural network 114 into a SCM, represented by the causal graph 139 of FIG. 1. As described above, the reduction 403 of FIG. 4 also illustrates an example of a network-to-graph conversion as a marginalization process for removing the hidden layer cells 420, 422, 424 of the neural network 402 to obtain the SCM 404.

An average causal effect (ACE) may be determined for all relevant input/output nodes at the selected timestep (906). For example, the node selector 142 of FIG. 1 may relate one or more output nodes of the neural network 114 to the investigated third event 132 and may use the causal graph 139 to relate corresponding output nodes 122a and/or 124a thereof to relevant, connected input nodes 116a, 118a. Similar comments apply to the SCM 404 of FIG. 4, with respect to the output nodes 414a, 416a, 418a and connected ones of the input nodes 408a, 410a, 412a.

As shown and described, e.g., with respect to the multi-variate example of FIG. 3, there may be many different inputs and outputs corresponding to collected performance metrics of a system being monitored. However, it is not necessary to calculate an ACE for all such variables, as the described techniques enable investigation of specific variables of a specific output neuron(s) corresponding to the investigated third event 132.

The intervention manager 144 may then proceed with determining the ACE values of individual edges of the edges 140 of FIG. 1, or of the edges 426-438 of FIG. 4, using the attribution calculator to perform the do calculus operation(s) 405 of FIG. 4. As described in those examples, and again in more detail below, with respect to FIG. 10, the intervention manager 144 may assign an ACE value to all relevant edges, and then remove all edges having ACE values below an attribution threshold. The attribution threshold may be an absolute, assigned value, and/or may be determined be selecting a number or percentage of edges having the lowest ACE values for deletion.

In FIG. 9, confounders may be removed (908). Also, one or more conclusion testing techniques may be used to determine whether a current iteration of the illustrated process should be a final iteration. For example, a timestep depth may be set that determines a maximum number of timesteps backwards in time that should be taken from the initial timestep of the investigated event. If such a depth has not been reached (910), then the process may continue.

Additionally, or alternatively, a minimum ACE value may be set that is selected to indicate that causal relationships calculated in a current iteration are too low to be of practical value, so that the current iteration (timestep) should be a final iteration. For example, at a current timestep, it may occur that a highest-calculated ACE value is below the attribution threshold. In FIG. 9, if the timestep depth has not been met (910) and at least the ACE minimum condition(s) have been met (912), then operations may proceed to a next iteration by selecting the next preceding timestep (902), i.e., that occurred prior to the timestep just processed.

In the next iteration, it may or may not be required or preferred to reconvert the neural network to a SCM (904). That is, it may be possible to partially or completely recycle the SCM of the preceding iteration.

When determining ACE values for relevant input/output neurons (906), it will be appreciated that neurons (or corresponding nodes) may be selected based in part on results of ACE calculations of the preceding iteration. That is, it may not be necessary to further investigate neurons for which edges were eliminated in the preceding iteration as being below the attribution threshold. Using this type of greedy search procedure, an exhaustive testing of all nodes and all corresponding edges may be avoided.

Confounders may then be removed (908). For example, the confounder filter 148 may test for and identify any edges initially identified as causal by the intervention manager 144, which are actually correlated by presence of a confounder node. Techniques for identifying confounder nodes and related correlated edges are referenced above with respect to FIGS. 6 and 7 and described below in more detail with respect to FIG. 11.

If the timestep depth has not been reached (910) and the ACE minimum has been met (912), processing may continue to a subsequent iteration and selection of a next-preceding timestep (902). In some cases, there may be no relevant input/output neurons at a particular timestep/iteration, in which case operations may proceed to a next preceding timestep if conclusion conditions (910, 912) have not been met.

For example, considering the causal chain 506 of FIG. 5 as an example implementation of FIG. 1, it may occur that the node 508 is analogous to the investigated third event 132, and the node 512 is analogous to the second event 130 and occurs one time step earlier, as shown by the edge 510. Then, the node 516 may correspond to the first event 128, but may occur six timesteps earlier, as shown by the edge 514. In such scenarios, iterative operations may be conducted at each of the intervening six timesteps to determine that no causal nodes with ACE values above the attribution threshold exist, so that corresponding nodes and edges may be omitted.

More particularly, causal testing may be performed at each iteration between both successive (adjacent) and non-successive timesteps. For example, when performing causal intervention testing for the investigated third event 132, intervention testing may be performed between the event pair, third event 132 and second event 130, the event pair , second event 130 and first event 128, and directly between the event pair, third event 132 and first event 128. Stated more generally, intervention testing starting at timestep Tₙ may be performed between Tₙ and Tₙ₋₁, Tₙ and Tₙ₋₂, Tₙ and Tₙ₋₃, and so on until conclusion conditions are met. Testing is also performed between Tₙ₋₁ and Tₙ₋₂, Tₙ₋₁ and Tₙ₋₃, and so on until conclusion conditions are met. All such testing may be performed in parallel when feasible. Moreover, as also noted, it is not necessary to test all nodes/neurons at each testing step, since testing is only performed for those nodes/neurons determined to be potentially causative of the event being investigated.

Once conclusion conditions have been met (910, 912), the various causal chains determined using the above techniques may then be aggregated (914). For example, the causal chain aggregator 152 may merge the various causal chains calculated using parallel processing into a single causal chain, such as shown in the causal chain 506 of FIG. 5. Although not illustrated as such in FIG. 9, confounder analysis may be performed or repeated at this stage in order to ensure removal of all potential confounders.

Finally in FIG. 9, root cause analysis may be performed (916). For example, a network centrality algorithm may be used to rank the nodes of the aggregated causal chain based on, e.g., a total number of outgoing edges across the aggregated causal chain and/or on ACE values of the edges, or weighted combinations thereof. More detailed examples of root cause analysis are provided below, with respect to FIG. 12.

FIG. 10 is a flowchart illustrating more detailed examples of the intervention testing of FIG. 4, corresponding to the operation 906 of FIG. 9. As described above, average casual effect (ACE) measures the causal effect of a particular input neuron on a particular output neuron of the network using an interventional expectation and the baseline.

In FIG. 10, intervention testing begins by selecting relevant output neurons and input neurons (1002). For example, for an event being investigated, a corresponding SCM may be used to determine input nodes (neurons) that might have a causal effect thereon.

Then, for an input neuron to be tested, other variables that may be potential causes (are connected in the SCM) may be set constant (1004). A baseline value may be calculated (1006). Then, an interventional expectation may be calculated (1008) using the equation provided above with respect to FIG. 5 and appropriate intervention test values. The baseline value(s) may then be removed to determine the average net effect of the interventions (1010).

If more variables are present (1012), then the described processes may continue for each variable. That is, a tested variable may be modified with intervention test data while non-tested variables are held constant, and a net intervention effect may be determined as the ACE.

Once all relevant variables have been tested (1012), edges below the attribution threshold may be removed (1014). For example, edges with the lowest ACE values may be deleted. In other examples, e.g., when the attribution threshold is known ahead of time, edges may be retained or removed when calculated.

FIG. 11 is a flowchart illustrating more detailed examples of the confounder filtering of FIGS. 6 and 7, and operation 912 of FIG. 9. In FIG. 11, an effect to be tested is selected (1102), along with a potential cause (1104). Then, values of the potential cause may be randomly permuted across multiple preceding timesteps (1106). In this way, a corresponding modified ACE value referred to as ACE_{I} may be calculated (1108).

If ACE_{I} is not lower than (e.g., remains similar in value to) the ACE value (1110), then the potential cause may be determined to be a confounder (1112). However, if the ACE is less than the corresponding ACE value, then the potential cause may be classified as being causal (1114).

Thus, described techniques measure the randomized ACE to identify whether a direct causal effect exists, or a correlated effect through an intermediate variable because of a confounder. Described techniques of FIG. 11 effectively use permutation importance as a chronologicity check (CC), where permutation feature importance is defined as the decrease in a model score when a single variable value is randomly shuffled. That is, the effect of a variable can be rendered as a causal effect if the observed data structure is consistent and chronologically ordered (without having a measured or latent confounder or without underlying randomization). Permuting a time series value removes chronologicity and therefore breaks a possible causal relationship between cause and effect.

To find potential causes, the ACCD manager 102 calculates ACE values as described above with respect to FIG. 10. To validate a potential cause, as shown in FIG. 11, a randomized intervened dataset may be generated for each potential cause Yₘ ∈ Pₙ. This is similar to the initial input dataset, but the values of a possible cause until an intervened variable timestep Yₘ ∈ Pₙ are randomly permuted. Since random permutations do not alter the distribution of the dataset, the model does not have to be retrained. Therefore, a potential cause may be learned on the randomized intervened dataset to predict Yₙ and measure the intervention ACE_{I}.

As also described with respect to FIG. 11, if potential cause Yₘ is a real cause of Yₙ, ACE_{I} based on the randomized intervened dataset will be worse, as the chronology of Yₘ was removed. Therefore, the intervention ACE_{I} of the case should be significantly lower than the actual ACE where the original dataset is used. If ACE_{I} is not significantly lower than ACE, then Yₘ is not a cause of Yₙ, since Yₙ can be predicted without the chronological order of Yₘ. Only the time series in Pₙ that are validated are considered true causes of the target time series Yₙ. Then, Cₙ may be used to denote the set of all true causes of Yₙ and Pₙ as the set of all potential causes of Yₙ. For example, referring back to FIG. 7, node X1 702 and node X2 706 are potential causes for node X3 710 based on the average causal effect. The chronologicity check determines whether these causes are true causes of the node X3 710. When the values of X1 are randomly permuted to predict X3, the randomized intervention ACE_{I} will probably be lower than actual ACE, since the model has no access to the chronological order of the values of confounder X1. However, if the chronologicity check is applied to X2, the ACE probably will not vary significantly, because the model still has access to the chronological order of the values of confounder X1 to predict X3. Then, only X1 may be determined to be a true cause of X3.

To determine whether an increase in average causal effect between the original dataset and the randomized intervened dataset is sufficient to distinguish a causal effect from a correlated effect, a percentage of increase may be determined. However, this required increase in ACE may be dependent on the dataset being used. For example, a model trained on a dataset with definite patterns will decrease ACE relatively more in comparison to one that is trained on a dataset without definite patterns. A procedure Permutation Importance Function (PIF) may be used to determine when an increase in ACE between the actual dataset and the randomized intervened dataset is relatively significant. For example, PIF may be based on the ACE as a user-defined parameter sig ∈ [0, 1] as a measure of significance. For example, a significance of sig = 0.8, or any suitable value, may be used.

FIG. 12 is a flowchart illustrating more detailed examples of the root cause analysis of FIG. 8, corresponding to operation 916 of FIG. 9 and the root cause inspector 154 of FIG. 1. In FIG. 12, a node of an aggregated causal chain may be selected (1202). For example, a node of the causal chain 506 of FIG. 5 may be selected.

A number and weight of each outgoing edge or connection may be determined (1204). For example, a weight be assigned as, or using, an ACE value of each edge.

If there are more nodes (1206), then the next node may be selected (1202) and the number of edges, and weight of each edge, may be determined (1204). Otherwise, if there are no more nodes (1206), the nodes may be ranked to find a likely root cause node (1208). Node inspection may begin, for example, with either a beginning or ending node of a causal chain, as long as all nodes are considered for purposes of ranking. Also, as referenced above, multiple techniques may be used to perform the node ranking, using the determined edge counts and weights, and combinations thereof.

For example, probable root cause identification may include ranking graph vertices in their order of impact and importance, while reducing causal chains having multiple causal paths, and retaining the longest impacted path. For example, a ranking algorithm may be used to analyze connectivity between event graph nodes to rank high impact causal nodes. Cumulative effects of different causal priors may be used to determine a weighted directed graph.

In more specific examples, eigenvector network centrality may be used to identify the probabilistic root causes. For example, to identify an entity (node) having the maximum amount of causal inference on the rest of the nodes, significance may be assigned depending on the number and importance of outward connections from a specific entity. The influence of an entity present in a weighted directed graph may be measured as the cumulative impact score of entities having a connected edge, which will, in turn, be multiplied by respective edge weights.

For example, in the equation C_{eig} (k)= ∑ Wₖⱼ Xj, with a summation performed over j ∈ Lk, C_{eig}(k) is the significance of entity k, Lₖ is the list of entities with associations to Xj, and Wₖⱼ are records of an edge weight matrix W. Setting the edge weight matrix W should be column-stochastic, so that the sum of all the columns should be one, and also the records are real and positive representing a standard for the strength of the connection between entities.

Also, for example, the problem may be represented as a conventional eigenvalue problem, i.e., Wx = λx. Even though many eigenvalues λ may be obtained with respect to several eigenvectors x, which can satisfy the above equation, those eigenvectors that have all positive records and with an eigenvalue of unity, i.e., λ = 1, provide corresponding significance scores. The resulting eigenvector is the eigenvector associated with the probability vector specified on the stochastic matrix. Its presence and uniqueness are guaranteed by the Perron-Frobenius theorem.

With reference to FIG. 8, the importance of the entities may be observed with reference to the heat map 824. The centrality of an entity may be observed to be proportional to its neighbor’s importance. FIG. 8 also illustrates that individual entities having the same number of connections as one another are not considered to be equally important in the heat map 824. Instead, entities connected to more central entities are significantly hotter in the visualization of heat map 824. FIG. 8 also illustrates that entities having fewer numbers of incoming connections may contribute significantly more to each node. Hence, the entity (node) 802, which is at the top right, is associated with a single but very important entity, even though, for example, the entity (node) 810 that is at the center has contributions from several high in-degree entities.

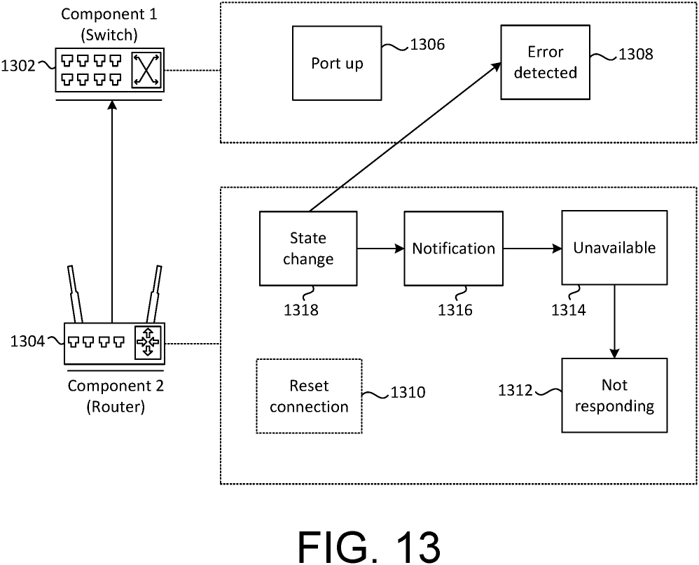

FIG. 13 is a block diagram of an example causal chain extracted using the techniques of FIGS. 1-11. FIG. 14 is a block diagram illustrating an example of root cause analysis using the causal chain of FIG. 13.

In FIG. 13, two components, a switch 1302 and a router 1304, are providing metrics corresponding to examples of the metrics 112 of FIG. 1, which are processed by a corresponding neural network 114 of FIG. 1. The switch 1302 illustrates events ‘port up’ 1306 and ‘error detected’ 1308. The router 1304 illustrates events ‘reset connection’ 1310, ‘not responding’ 1312, ‘unavailable’ 1314, ‘notification’ 1316, and ‘state change’ 1318.

In the example, it may occur that a complicated failure spans both components 1302, 1304. For example, an interface error on the router 1304 may result in repeated border gateway protocol (BGP) peering connections, which may correspond to a BGP connection resetting failure, that may appear sporadically on a BGP connection resetting process. Of course, the details of such examples are merely illustrative, and many other examples could be considered, as well.

In FIG. 14, ACE values 1402, 1404, 1406 are illustrated as having been calculated with respect to corresponding edges. Then, ranking scores 1408, 1410, 1412, and 1414 are illustrated as being calculated, e.g., using the techniques of FIG. 12. For example, it may be observed that the ranking scores 1408, 1410, 1412, and 1414 increase in a direction of the node 1318, because the ACE values also increase in that direction and because each node in that direction has a greater total number of outgoing edges. Accordingly, the node 1318 may be assigned the highest-ranking score, 1414, and may be designated as the probabilistic root cause node of the investigated event.

Described techniques provide a causal chain extraction method using attribution-based causal chain discovery (ACCD) for sequence prediction interpretability. Described techniques enable differentiation of measured confounders from direct causations, thereby increasing the accuracy of causal chain discovery and improving the sequence prediction interpretability. Probabilistic root causes may be identified from the causal chains extracted, using, e.g., a network centrality algorithm.

Implementations of the various techniques described herein may be implemented in digital electronic circuitry or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers, including mainframes and distributed servers, at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may, or be operatively coupled to, receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a non-transitory computer-readable storage medium and comprising instructions that, when executed by at least one computing device, are configured to cause the at least one computing device to:
monitor a system using a neural network trained to represent a temporal sequence of events within the system;
store system state data determined by the neural network, for each of a plurality of timesteps corresponding to the temporal sequence of events including a first event, a second event, and a third event;
using the neural network, perform first intervention testing to identify the second event as having a first causal effect with respect to the third event, including substituting first intervention test data within the system state data for processing by the neural network to determine the first causal effect;
using the neural network, perform second intervention testing to identify the first event as having a second causal effect with respect to the second event, including substituting second intervention test data within the system state data for processing by the neural network to determine the second causal effect; and
generate a causal chain of events that includes the first event, the second event, and the third event, based on the first intervention testing and the second intervention testing, and including the first causal effect and the second causal effect.

2. The computer program product of claim 1, wherein the neural network includes a long short-term memory (LSTM) network.

3. The computer program product of claim 1, wherein the instructions, when causing the at least one computing device to perform the first intervention testing, are further configured to cause the at least one computing device to:
convert the neural network into a structural causal model (SCM); and
identify the second event for testing based on a connection between the second event and the third event determined using the SCM.

4. The computer program product of claim 3, wherein the instructions are further configured to cause the at least one computing device to:
convert the neural network to the SCM by marginalizing hidden layers of the neural network to determine direct connections between input neurons and corresponding output neurons of the neural network.

5. The computer program product of claim 1, wherein the instructions are further configured to cause the at least one computing device to:
perform the first intervention testing to calculate the first causal effect as a first average causal effect (ACE) corresponding to multiple values for the second event in the first intervention test data when processed by the neural network, relative to a baseline value of the third event when processed relative to a baseline value for the second event.

6. The computer program product of claim 1, wherein the instructions are further configured to cause the at least one computing device to:
perform third intervention testing using the neural network to identify the first event as having a third causal effect with respect to the third event, including substituting third intervention test data within the system state data for processing by the neural network to determine the third causal effect.

7. The computer program product of claim 6, wherein the instructions are further configured to cause the at least one computing device to:
identify the second event as a potential confounder with respect to the third event;
perform randomized intervention testing of the second event using randomly permuted values of a variable of the second event over a plurality of timesteps to determine a randomized causal effect;
determine that the second causal effect is greater than the randomized causal effect; and
validate the second causal effect of the second event on the third event based on the second causal effect being greater than the randomized causal effect.

8. The computer program product of claim 1, wherein the instructions are further configured to cause the at least one computing device to:
determine the first event as a root cause of the third event, based on the first causal effect and the second causal effect.

9. The computer program product of claim 8, wherein the instructions are further configured to cause the at least one computing device to:
determine the first event as the root cause based on a number of outgoing edges of nodes of a causal chain graph constructed from the causal chain of events.

10. The computer program product of claim 1, wherein the first event occurs at a first timestep, the second event occurs at a second timestep, and there is at least one intervening timestep between the first timestep and the second timestep.

11. A computer-implemented method, the method comprising:
monitoring a system using a neural network trained to represent a temporal sequence of events within the system;
storing system state data determined by the neural network, for each of a plurality of timesteps corresponding to the temporal sequence of events including a first event, a second event, and a third event;
using the neural network, performing first intervention testing to identify the second event as having a first causal effect with respect to the third event, including substituting first intervention test data within the system state data for processing by the neural network to determine the first causal effect;
using the neural network, performing second intervention testing to identify the first event as having a second causal effect with respect to the second event, including substituting second intervention test data within the system state data for processing by the neural network to determine the second causal effect; and
generating a causal chain of events that includes the first event, the second event, and the third event, based on the first intervention testing and the second intervention testing, and including the first causal effect and the second causal effect.

12. The method of claim 11, wherein performing the first intervention testing comprises:
converting the neural network into a structural causal model (SCM); and
identifying the second event for testing based on a connection between the second event and the third event determined using the SCM.

13. The method of claim 11, wherein performing the first intervention testing comprises:
calculating the first causal effect as a first average causal effect (ACE) corresponding to multiple values for the second event in the first intervention test data when processed by the neural network, relative to a baseline value of the third event when processed relative to a baseline value for the second event.

14. The method of claim 11, further comprising:
performing third intervention testing using the neural network to identify the first event as having a third causal effect with respect to the third event, including substituting third intervention test data within the system state data for processing by the neural network to determine the third causal effect.

15. The method of claim 14, further comprising:
identifying the second event as a potential confounder with respect to the third event;
performing randomized intervention testing of the second event using randomly permuted values of a variable of the second event over a plurality of timesteps to determine a randomized causal effect;
determining that the second causal effect is greater than the randomized causal effect; and
validating the second causal effect of the second event on the third event based on the second causal effect being greater than the randomized causal effect.

16. The method of claim 11, further comprising:
determining the first event as a root cause of the third event, based on the first causal effect and the second causal effect.

17. A system comprising:
at least one memory including instructions; and
at least one processor that is operably coupled to the at least one memory and that is arranged and configured to execute instructions that, when executed, cause the at least one processor to:
monitor a system using a neural network trained to represent a temporal sequence of events within the system;
store system state data determined by the neural network, for each of a plurality of timesteps corresponding to the temporal sequence of events including a first event, a second event, and a third event;
using the neural network, perform first intervention testing to identify the second event as having a first causal effect with respect to the third event, including substituting first intervention test data within the system state data for processing by the neural network to determine the first causal effect;
using the neural network, perform second intervention testing to identify the first event as having a second causal effect with respect to the second event, including substituting second intervention test data within the system state data for processing by the neural network to determine the second causal effect; and
generate a causal chain of events that includes the first event, the second event, and the third event, based on the first intervention testing and the second intervention testing, and including the first causal effect and the second causal effect.

18. The system of claim 17, wherein the instructions, when causing the at least one processor to perform the first intervention testing, are further configured to cause the at least one processor to:
convert the neural network into a structural causal model (SCM); and
identify the second event for testing based on a connection between the second event and the third event determined using the SCM.

19. The system of claim 17, wherein the instructions are further configured to cause the at least one processor to:
perform the first intervention testing to calculate the first causal effect as a first average causal effect (ACE) corresponding to multiple values for the second event in the first intervention test data when processed by the neural network, relative to a baseline value of the third event when processed relative to a baseline value for the second event.

20. The system of claim 17, wherein the instructions are further configured to cause the at least one processor to:
determine the first event as a root cause of the third event, based on the first causal effect and the second causal effect.
